(19) United States
(12) Patent Application Publication
(10) Pub. No.: US 2008/0099574 A1
(43) Pub. Date: May 1, 2008

(54) Decorative fountain

(76) Inventor: Chung-Kuei Lin, Sanchong City (TW)

Correspondence Address: BIRCH STEWART KOLASCH & BIRCH, PO BOX 747, FALLS CHURCH, VA, 22040-0747, US

(21) Appl. No.: 11/585,820

(22) Filed: Oct. 25, 2006

(51) Int. Cl. F21S 8/00

(52) U.S. Cl. 239/18; 362/96; 239/17

(57) ABSTRACT

A decorative fountain includes a top cap having an inner wall formed on top of a bottom face of the top cap and along an inner surface of the top cap so as to define a receiving space between the inner wall and the inner surface of the top cap, an opaque layer formed to enclose the receiving space, apertures defined in the bottom face of the top cap to communicate with an interior of the container and light emitting diodes electrically connected to the pump and received inside the receiving space for emitting light via the opaque layer so that water pumped upward is flowing back to the container while the light emitting diodes are emitting light via the opaque layer.

### BACKGROUND OF THE INVENTION

1. Field of the Invention

The present invention relates to a decorative fountain, and more particularly to a decorative fountain having multiple light eliminating elements equally distributed around a hollow core to provide light to the core when water is flowing out of the core from a top face of the core.

2. Description of the Prior Art

A decorative fountain in the art is provided with a pump received in a container, a hollow core standing upright from the container and an illuminator placed directly under the hollow core such that when the pump is activated to pump water in the container to flow out of the hollow core, the illuminator is able to provide lighting effect to the water flow.

The arrangement of the currently available decorative fountain does provide a soothing effect to human mind and soul. However, the single illuminator provides only lighting effect to the water flow. The illuminator can not create a romantic atmosphere where the lighting effect is soft.

To overcome the shortcomings, the present invention tends to provide an improved decorative fountain to mitigate the aforementioned problems.

### SUMMARY OF THE INVENTION

The primary objective of the present invention is to provide an improved decorative fountain capable of providing a soft and misty atmosphere.

In order to accomplish the aforementioned objective, the improved decorative fountain of the present invention includes a container for receiving therein water, a pump placed inside the container, a top cap detachably mounted on and supported by a top peripheral edge of the container, the top cap having a hollow core extending upright from a bottom face of the top cap, multiple apertures defined through the bottom face of the top cap, an opaque layer mounted to enclose a receiving space defined by an inner wall formed along an inner contour of the top cap and multiple light emitting diodes received in the receiving space such that when the water inside the container is pumped upward by the pump and flowing out of the hollow core, the light emitting diodes provide a misty and soft lighting effect to the flowing water.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the decorative fountain of the present invention;

FIG. 2 is an exploded perspective view of the decorative fountain of the present invention;

FIG. 3 is a cross sectional view of the decorative fountain taken by line 3-3 in FIG. 1; and

FIG. 4 is a perspective view showing a different embodiment of the hollow core.

### DETAILED DESCRIPTION OF THE PREFERRED EMBODIMENT

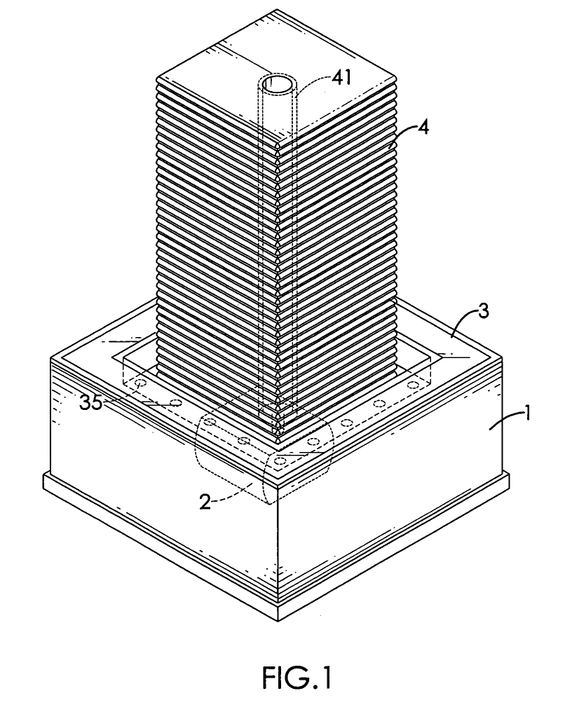

With reference to FIG. 1, it is noted that the decorative fountain constructed in accordance with the present invention includes a container (1) for receiving therein water, a pump (2) placed inside the container (1), a top cap (3) detachably mounted on and supported by a top peripheral edge of the container (1) and a hollow core (4) extending upright from a bottom face of the top cap (3).

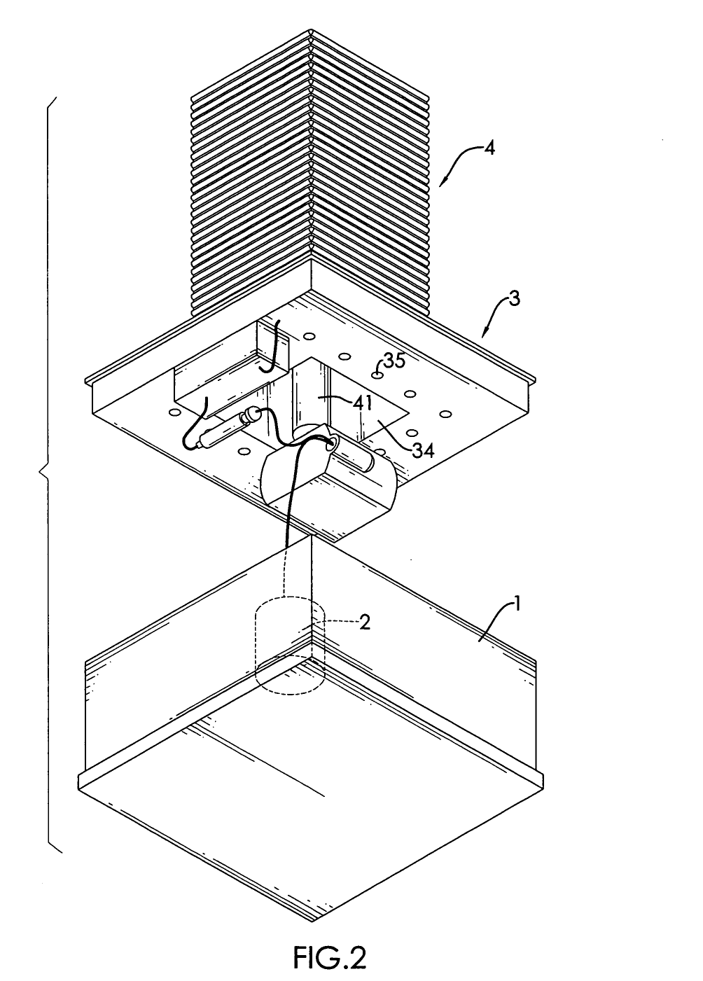

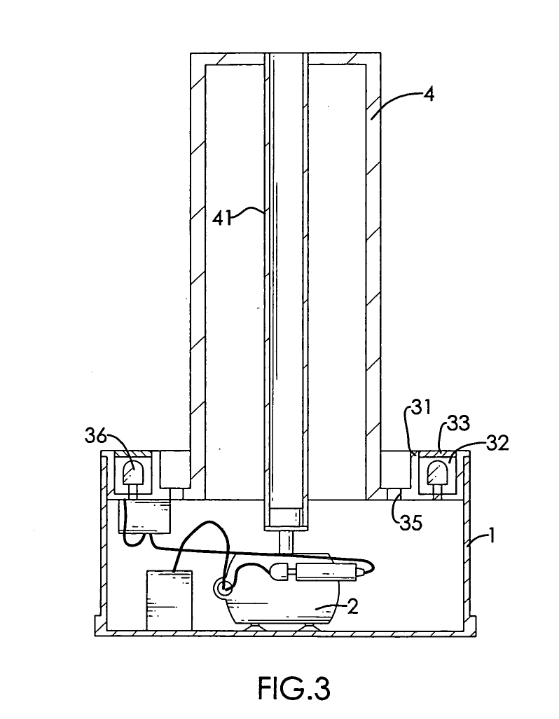

With reference to FIGS. 2 and 3, the container (1) is constructed to receive therein water and has a top open end and a closed bottom end. The top cap (3) is composed of a closed bottom end, and a top open end. An inner wall (31) is formed along an inner surface of the top cap (3) to define a receiving space (32) between the inner wall (31) and the inner surface of the top cap (3). An opaque layer (33) is mounted on top of the inner surface of the top cap (3) and the inner wall (31) to enclose the receiving space (32). A bottom through hole (34) is defined in a bottom face of the top cap (3) and multiple apertures (35) are defined in the bottom face of the top cap (3) to communicate with the container (1). Multiple light emitting diodes (LEDs) (36) are received in the receiving space (32).

The hollow core (4) is integrally connected to the bottom face of the top cap (3) adjacent to the through hole (34) and has a tube (41) extending through the hollow core (4). The tube (41) has two open ends respectively communicating with the container (1) and with the air.

The LEDs (36) are electrically connected to the pump (2) so that when the pump (2) is activated, the LEDs (36) are lit.

It is noted that when the pump (2) is pumping water out of the container (1) via the tube (41), the water originally received in the container (1) flows out of the container (1) via the tube (41) in the hollow core (4) and then flows back to the container (1) via the apertures (35).

While the water is flowing, the light from the LEDs (36) is emitted via the opaque layer (33) to show a misty and soft lighting effect to the flowing water.

From the above description, it is noted that the LEDs (36) are arranged along the bottom face of the top cap (3) so that the lighting effect is even and because of the provision of the opaque layer (33), the lighting effect is soft.

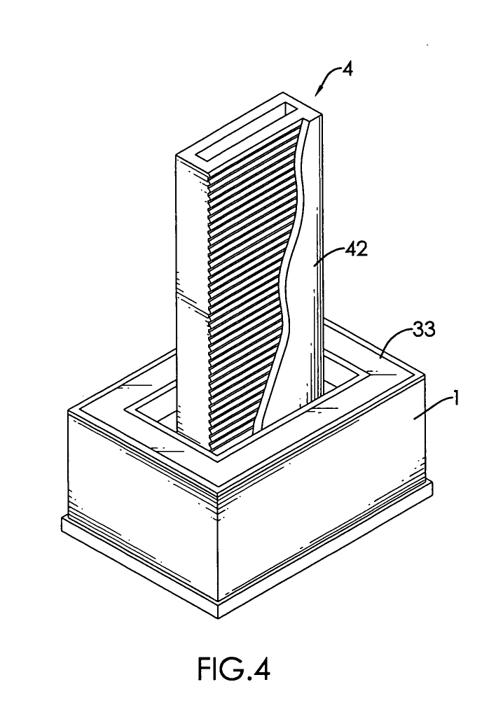

With reference to FIG. 4, it is noted that the hollow core (4) may be provided with a pattern (42) formed on an outer face of the hollow core (4) to increase attraction and decorative effect thereof.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A decorative fountain consisting of:
a container for receiving therein water;
a pump securely received inside the container for pumping water upward;
a top cap detachably mounted on top of the container and supported by a peripheral edge of the container, the top cap having an inner wall formed on top of a bottom face of the top cap and along an inner surface of the top cap so as to define a receiving space between the inner wall and the inner surface of the top cap, an opaque layer formed to enclose the receiving space, apertures defined in the bottom face of the top cap to communicate with an interior of the container and light emitting diodes electrically connected to the pump and received inside the receiving space for emitting light via the opaque layer; and
a hollow core extending upward from the bottom face of the top cap and having a tube extending inside the hollow core, the tube having two open ends respectively communicating with the interior of the container and air such that when the pump is activated to pump water to the tube, the light emitting diodes are lit and the water flowing upward via the tube is flowing back to the container via the apertures.

2. The decorative fountain as claimed in claim 1, wherein a pattern is formed on an outer face of the hollow core.
